(19) United States
(12) Patent Application Publication
(10) Pub. No.: US 2025/0048956 A1
(43) Pub. Date: Feb. 13, 2025

(54) AUTOMATED SYSTEM AND METHOD FOR PLANTING NURSERY SEEDLINGS

(71) Applicants: Marcello GUIMARÃES MACHADO FREIRE; Eduardo GUIMARÃES MACHADO FREIRE

(72) Inventors: Marcello GUIMARÃES MACHADO FREIRE; Eduardo GUIMARÃES MACHADO FREIRE

(21) Appl. No.: 18/285,344

(22) PCT Filed: Jul. 27, 2022
(86) PCT No.: PCT/BR2023/050034

§ 371 Date: Oct. 2, 2023

(30) Foreign Application Priority Data
Feb. 2, 2022 (BR) 1020220020078

(51) Int. Cl. A01C 11/02; A01B 49/06; A01C 11/00; A01G 29/00; A01M 7/00

(52) U.S. Cl. CPC A01C 11/025; A01C 11/006; A01G 29/00; A01M 7/0092; A01B 49/06; A01M 7/0085

(57) ABSTRACT

The present invention belongs to the autonomous and precision agriculture sector, and refers, more specifically, to a system for seedling planting machines with a focus on reforestation and forestry (silviculture) for mechanized planting, in areas of installation, renovation and/or recovery of degraded areas with minimal impact on the environment, self-propelled, which plants from 1,800 to 3,600 seedlings per hour, in a sliding and continuous system, with water or gel irrigation, guaranteeing the quality of planting with an intelligent system, which checks each seedling, evaluating whether there has been drowning of the collection, exposure of the substrate, if the seedling is inclined, indicating even if the seedling was not planted and where it happened, generating a planting map (KML) with the GPS position of each seedling.

### TECHNOLOGICAL SECTOR AND SUMMARY OF THE INVENTION

The present invention belongs to the autonomous and precision agriculture sector, and refers, more specifically, to a seedling planting machine with a focus on reforestation and/or afforestation (silviculture) for mechanized planting, in areas of installation, renovation and/or recovery of degraded areas with minimal impact on the environment, self-propelled, which plants from 1,800 to 3,600 seedlings per hour, in a continuous and sliding system, with automatic pilot that directs the machine to follow a line of movement pre-programmed, guaranteeing the quality of planting with an intelligent system, which checks each seedling, assessing whether the stem has drowned, exposure of the substrate, whether the seedling is inclined, even indicating whether the seedling was not planted and where the seedling occurred. error (exact GPS position); able to inject gel together with the seedling, irrigate each seedling allowing the coupling of the machine to a barrel of up to 8 thousand liters, apply ant poison in the position indicated by the system, check if there is any obstacle (root, stump, trunk, stone, clod, dirt, etc.) in the exact place where the seedling will be “injected” using GPR (ground penetration radar) and mechanical verification, press around the seedling to create a basin that will receive the irrigation and remove air pockets that could compromise the good development of the plant, georeferencing each seedling creating a digital planting map and planting at speeds that can vary from 4 km/h to 8 km/h with independent suspension on the 4 wheels with a hydrostatic system, which maintains the planting system (planting nozzle) always leveled through an intelligent hydraulic system, which uses a gyroscope and accelerometer to stabilize the entire planting system while the machine moves in the field, keeping the nozzle always at the correct height and level to obtain better quality when planting seedlings.

### State of the Art

There are different terms for planting trees: reforestation and forestation. There are some definitions for these terms, but the difference between them is basically what is found in the areas to be planted: Afforestation can be understood as planting in areas where, historically, there was no forest; Reforestation is planting in areas where, historically, there was forest, but which were converted by human beings to other uses.

Large constructions, such as hydroelectric dams, highways, mining, intensive agriculture, livestock, urban expansion and logging, result in high rates of environmental degradation and the destruction of ecosystem services.

To measure the size of the problem, Brazil was the country that most lost forest areas between 2010 and 2015 in the world, around 984 thousand hectares per year according to a UN report. A large part of deforestation is carried out through fires, which are one of the main reasons for the emission of carbon dioxide and particulate matter in the country. About 75% of CO₂ emissions come from deforestation and fires, which release carbon accumulated in tree biomass.

Forests bring many benefits, including capturing CO₂ from the atmosphere through photosynthesis, recovery of a degraded area and improvement of soil quality, avoiding erosion, reduction of surface runoff, climate deregulation, among others.

Firstly, it is necessary to prepare the soil to receive the planting of seedlings in areas of reform (prior elimination of re-sprouted strains, through the use of post-emergent herbicides) or implantation.

Then the furrowing operation is carried out, based on the concept of minimum cultivation. It is carried out with the aim of breaking up possible compacted soil layers and facilitating pitting and the application of pre-emergent herbicide. As a result, it guarantees rapid seedlings, greater planting uniformity and rapid growth in the initial planting phase.

Coveamento is the technique used to open the holes, through the use of hoes (manually) or with forest subsoiler. The pits should preferably be made with a specific width and depth in the desired spacing.

Before fertilization, it is recommended to carry out soil analysis to recommend liming and fertilization. Planting fertilization aims at supplying nutrients in the initial phase of the plant's life, carried out manually in a mixture in the planting hole. On the other hand, top dressing applies only to very low fertility soils.

The planting of seedlings is carried out manually, through the use of appropriate tools. Right after planting, the planted seedlings are irrigated.

Depending on the post-planting climatic conditions, complementary irrigations are carried out.

Subsequently, replanting and irrigation is carried out only in areas (plots) that have failure rates equal to or greater than 10% (clone) and 15% (seed) for spacing between seedlings less than or equal to 9 m³ per plant. For larger spacings, a maximum failure rate of 3% is considered, regardless of the genetic material.

The number of manual operations is predominant, plus the fact that a large part of the planting is carried out in renovated areas, that is, where there has already been planting in the soil and which needed to be prepared to receive new seedlings, a solution to this problem becomes urgent, considering that the aim is a scaled production, with low cost and that can be carried out in any soil. Therefore, a machine that could carry out the correct planting in large quantities, taking care and verifying that the seedling was properly allocated to the soil would be an excellent resource.

For this, it would be essential that said machine have a continuous and sliding planting system to allow the machine to plant continuously, without stopping and at any speed, allowing that, regardless of the machine's displacement speed, the planting of each seedling has quality and it is not necessary to replant any seedling, that the displacement of the nozzle on the support rails is inertial so that it is not necessary to synchronize the displacement speed of the machine with the planting speed of each seedling and the touch of the planting beak in the ground; to prepare the basin to receive and install the irrigation; that you could plant with gel injected into the soil or with irrigation on the seedling and that the application of irrigation is smooth and continuous so as not to harm the newly planted seedling; that has autonomy for few stops, that has an automatic pilot capable of following the fertilization line to plant the seedlings where there is fertilizer previously buried in the soil; that had a suspension system to suit uneven ground; that could record the GPS position (georeferencing) of each seedling in a database and verify the planting quality using artificial intelligence, and present the planting quality in real time to the machine operators; that has real-time telemetry to assist in corrective and preventive maintenance of the machine; that it can take enough seedlings to not make many refueling stops; in addition to combating ants that can harm the planting in its initial phase.

It can be mentioned some patent documents that are committed to the same objective of the invention, such as BR 202017018034-0 entitled “Vehicle suitable for planting seedlings” which reveals a machine with a tray system with seedlings, a soil cutter disc, fertilizer and chemical tanks to spray the planting, with wheels. And the patent document BR 102017013996-4 entitled “Utility vehicle” which demonstrates a vehicle with a fertilizer, gel and chemical deposit with an automated planting system. In summary, these are very particular solutions that do not anticipate the intended characteristics, as well as the machines that are coupled to agricultural vehicles that do not belong to the same inventive concept as the solution.

### Invention Novelties and Advances

In view of this, the present invention presents a system for planting tree seedlings (native or exotic), using a sliding and continuous planting system. Plant from 1,800 to 3,600 seedlings/h, and the machine that receives the system can operate at speeds ranging from 4 to 40 km/h. It has autonomy to plant 2 to 4 hectares per load and plant with gel injected into the soil or with irrigation on the seedling (up to 4 liters of water per seedling, selected through the machine's software).

Uses an active suspension system to “copy” the soil and keep the machine always on the correct level for better planting quality for each seedling and also to overcome dirt (obstacles such as stumps, trunks, sticks, roots, remains of cut trees, among other obstacles in the way of planting), records the GPS position (georeferencing) of each seedling in a digital database that can be transferred to the cloud, checks using artificial intelligence the planting quality (if the seedling is not inclined, if there was no “drowning” of the stem, if the substrate is not exposed), and it presents in real time the planting quality to the machine operators on a computer monitor or tablet. The continuous and sliding planting system allows the machine to plant without requiring synchronization between machine speed and planting, ensuring that there will be no failures in planting, regardless of how the machine is operated or its speed of movement. The planting system guarantees the compaction of the seedling to avoid air pockets in the soil, which compromises the quality of planting and can “kill” the seedling, creates a “basin” in the soil to deposit water at the base of the seedling, and plant seedlings always pointing upwards, regardless of the slope of the land. It performs electronic and mechanical tests on the surface of the soil and underground to plant in positions that do not have obstacles, such as: stones, clods, trunks, stumps, roots, apparent or buried.

The invention applies ant poison, plant with gel, irrigates the seedling at the time of planting to form a “swimming pool” full of water, and plants any nursery species (seedlings of exotic, native, fruitful or ornamental trees that are produced in a nursery). It does not plant seeds, and performs all these actions, dispensing with the use of tractors (the machine is self-propelled), saving machine, diesel and operator hours. In a 24-hour cycle you can plant between 25 and 50 hectares. The invention suggests that the machine has a 130 hp engine, gearbox, hydrostatic transmission, intelligent suspension. It records the position of each seedling with GPS and records the digital planting map in the cloud, in addition to checking the planting quality of each seedling using a sophisticated and modern Artificial Intelligence system. And it works with IoT systems, GPS, cloud data base, Al and seedling spacing adjustable at runtime via machine control panel (by computer monitor or tablet). It uses the GPR (Ground Penetration Radar) system to check for obstacles on the ground and inside the ground, thus ensuring that the seedlings will be planted only in places that do not have any obstacles that prevent correct and quality planting so that the seedling can develop.

### DESCRIPTION OF THE ATTACHED DRAWINGS

In order for the present invention to be fully understood and put into practice by any technician in this technological sector, it will be described in a clear, concise and sufficient manner, based on the attached drawings, which illustrate and support it, listed below:

FIG. 1 represents a perspective view of a machine with a sliding and continuous planting system, with a support for seedling trays and a carousel that dispenses seedlings one by one during the planting operation;

FIG. 2 represents the front view of a machine with the planting system, featuring a front compressor roller for homogenizing the soil and accumulating material to facilitate the “injection” of the seedling into the soil;

FIG. 3 represents a perspective view of a machine with a planting system, with a water reservoir;

FIG. 4 represents the top view of the revolving supply for seedling trays;

FIG. 5 represents the top and bottom perspective views of the carousel, which receives and releases the seedlings for planting;

FIG. 6 represents the rear and lower perspective view of the planting beak;

FIG. 7 represents the perspective view of the planting beak leveling and stabilization system, with emphasis on detail A;

FIG. 8 represents the perspective view of the platform for leveling and stabilizing the planting system with the linear guide;

FIG. 9 represents the perspective view of the revolving supply of trays, the support shelves, the seedling carousel, the sliding and leveling system and the planting nozzle;

FIG. 10 represents the top perspective view of the cockpit with emphasis on the GPS antenna and the operator's monitor;

FIG. 11 represents the left side view of the machine with planting system, highlighting the radar, front camera, GPS and antenna and the ant deposit;

FIG. 12 represents the rear perspective view of the machine with emphasis on the rear camera, the ant deposit and the soil sensor;

FIG. 13 represents the right side view of the machine with planting system and irrigation water reservoir.

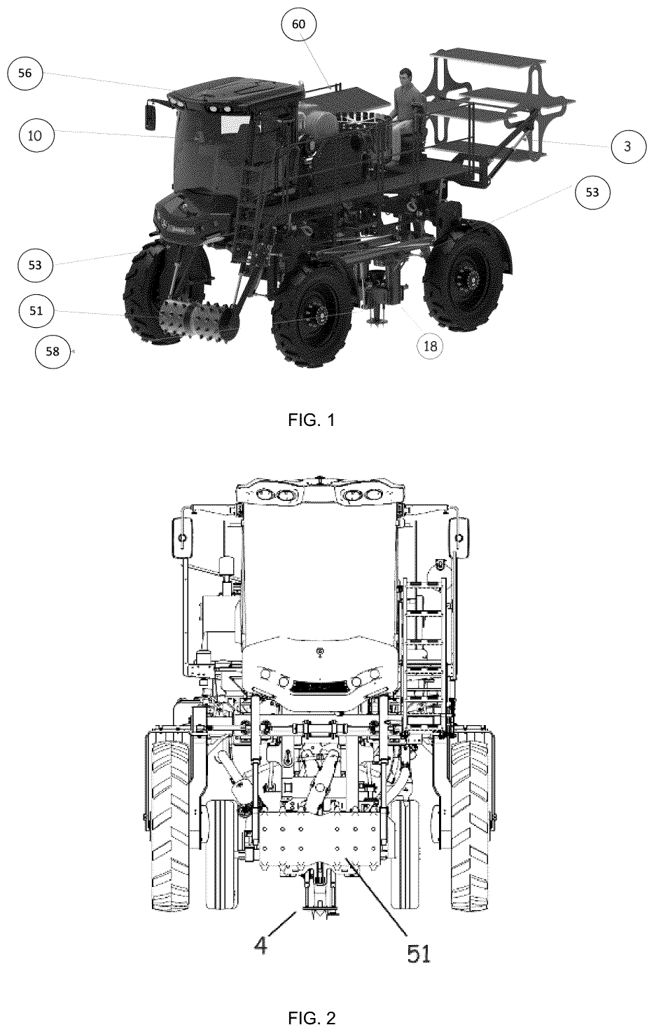

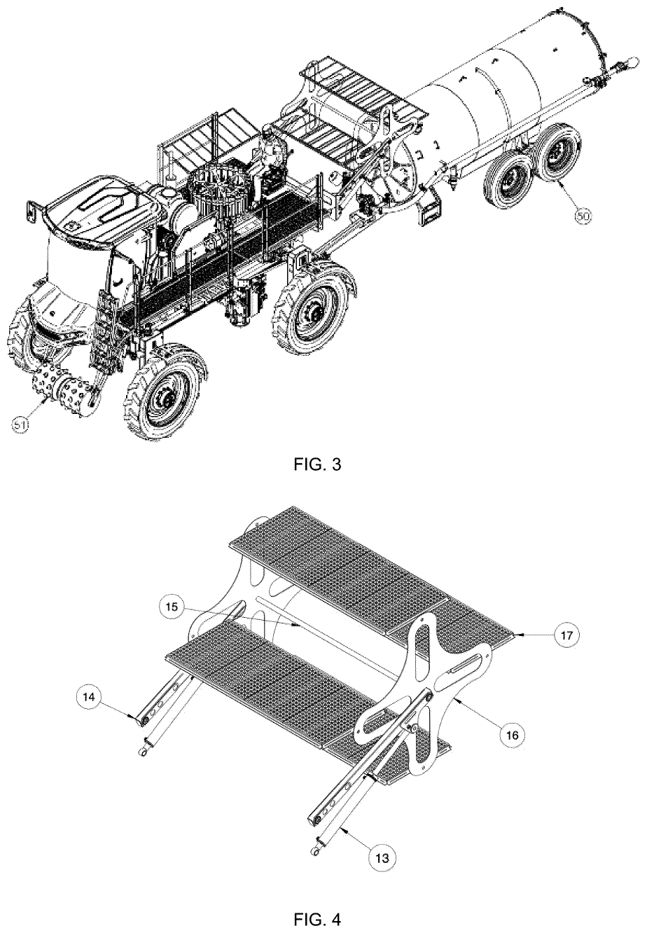

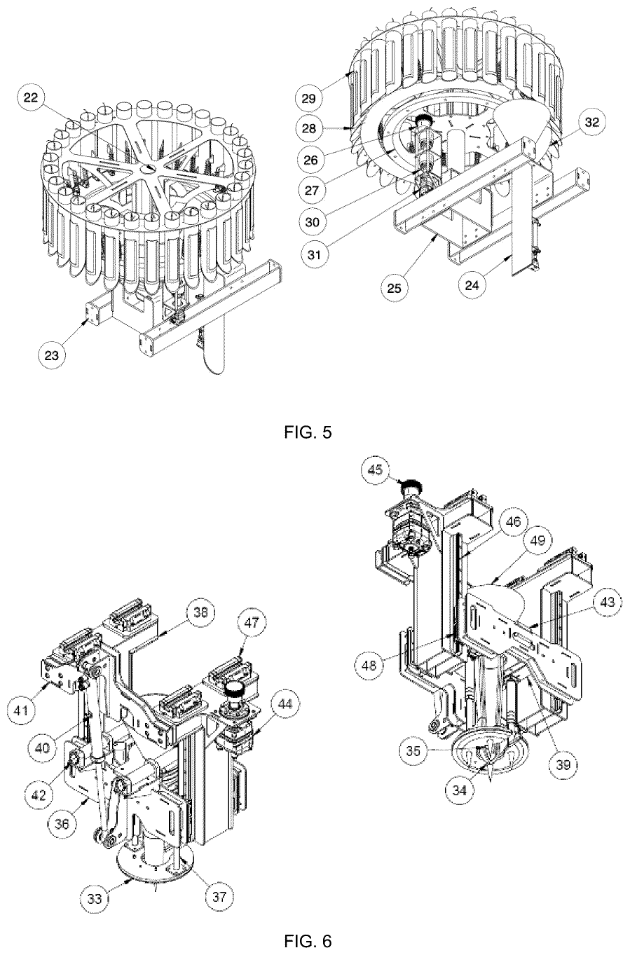

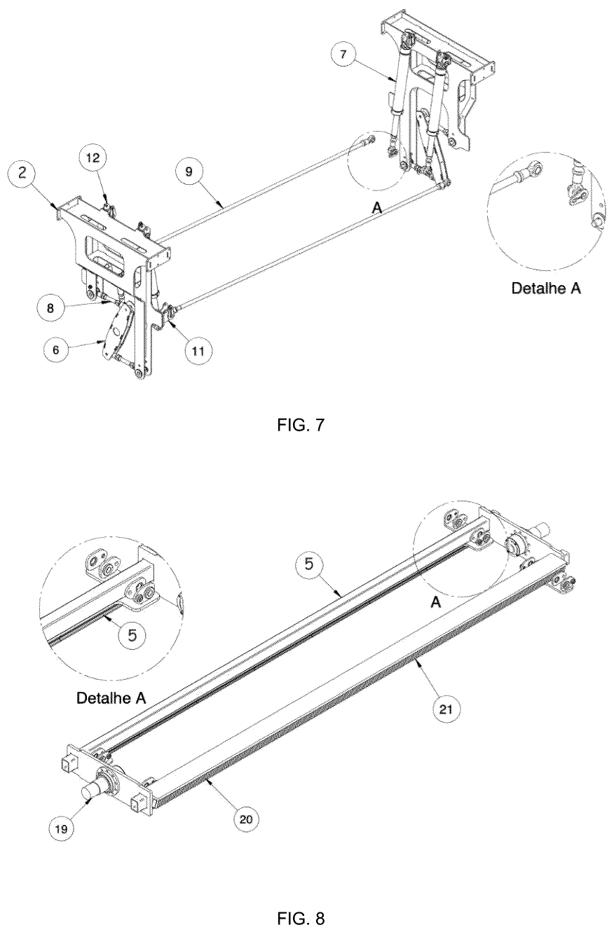

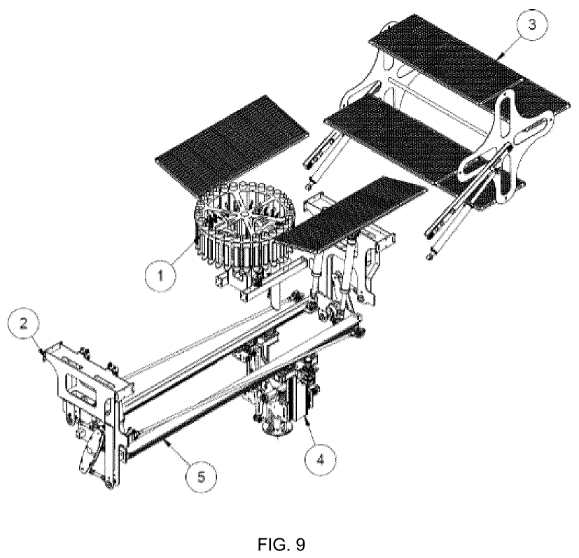

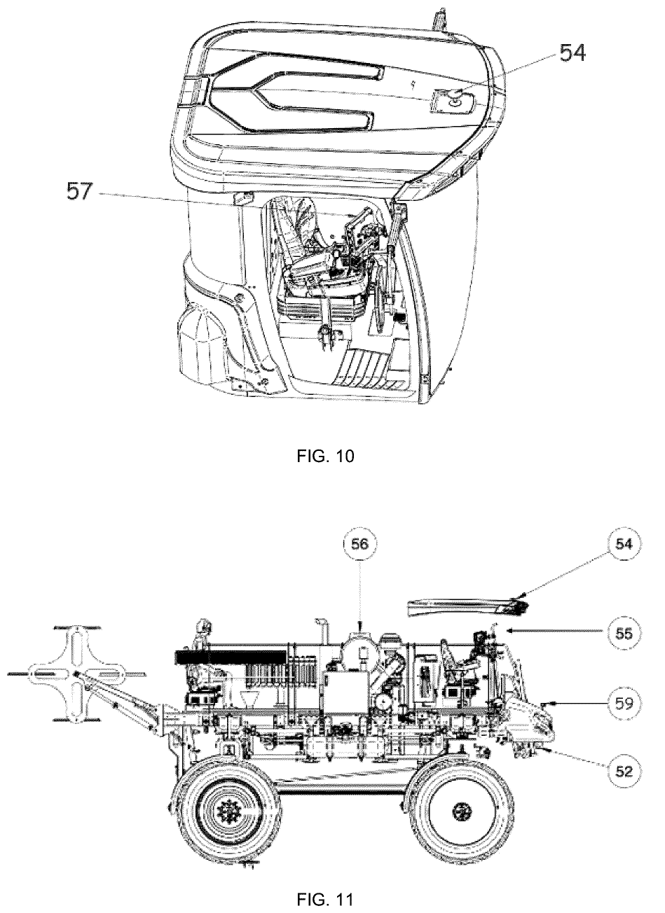

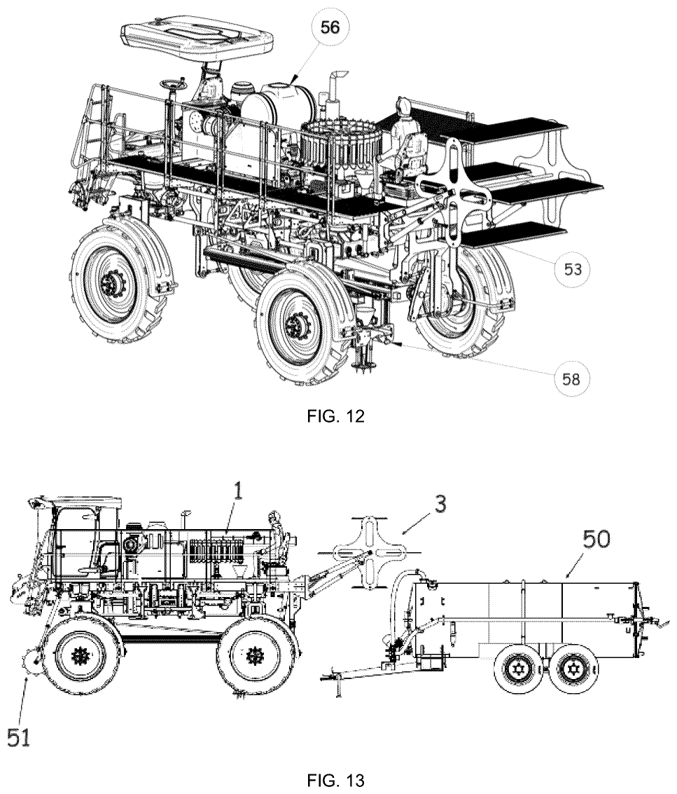

### DETAILED DESCRIPTION OF THE INVENTION

In general, the system applied to planting machines provides self-propelled; intelligent, terrain-adaptive suspension; hydrostatic transmission; exchange box; autopilot to guide it on the forest fertilizing line using a complete GPS system and navigation software; allows planting tree seedlings (native or exotic) in areas for installation or renovation, regardless of soil dirtiness, with irrigation and/or gel that is dispensed continuously to avoid damaging the seedling in amounts that can vary from 500 ml to 4 liters; apply insecticide during planting; records the seedling's GPS position with a KML digital planting map; performs the photographic record of each seedling with verification of the planting quality, which identifies: seedling inclination, stem drowning and exposure of the substrate; sliding and continuous planting system that dispenses with synchronization between the speed at which the machine moves over the ground and the speed at which the nozzle touches the ground to inject the seedling, with reading of the micro soil, where the planting nozzle follows the irregularities of the soil. land to plant always at the correct height; performs electronic and mechanical analysis of the soil and subsoil, identifying obstacles above ground or buried; it has a carousel for 30 seedlings (lines of 90 meters or more) that can be infinitely fed; selects planting spacing via software; and features operation monitor and telemetry for the driver and operator.

### General System Components

Engine for self-propulsion; Intelligent, terrain-adaptive suspension; Autopilot to drive the machine over the fertilizer line; Seedling irrigator; Planting gel applicator; ant applicator; GPS for orientation and to determine the planting position of each seedling; Automatic nozzle-to-ground distance adjustment system; Intelligent system, which uses a Neural Network to determine the quality of planting with a camera; GPR to locate obstacles within the soil that prevent the planting of seedlings and over the soil; Soil mechanical analysis to detect obstacles inside the soil and on the ground; Sliding and continuous planting system; Seedling injector system; Carousel with 30 seedlings; Planting and machine control and management system; real-time telemetry for all machine elements and all machine components, Monitor for machine operation and telemetry for driver and operator, and Hydrostatic transmission and system for remote machine monitoring. Next, the essential components of the system and those that contribute to improving the operation of the machine will be explained in detail.

From the Propulsion of a Machine With a Nursery Seedling Planting System

The present system will be introduced in a self-propelled agricultural implement and not a drag implement, that is, a machine that has an engine with a radiator and a gearbox with a power that can vary from 130 to 190 hp. The on-board technology has an agricultural engine with electronic injection, and can perform gears automatically according to the load and uses a hydrostatic transmission system with independent and intelligent suspension on each wheel.

### Independent and Intelligent Suspension

The intelligent hydrostatic suspension and propulsion system can be applied to a machine that receives the patent system, being non-essential, it guarantees the locomotion of the machine, overcoming obstacles in areas of planting reform in areas of reforestation. The system identifies obstacles ahead for each wheel and calibrates the hydraulic suspension to move each suspension piston up or down independently (not illustrated), thus ensuring that any obstacle can be overcome by keeping the machine level so that the planting system can inject the seedlings at the correct inclination. For this purpose, the suspension is formed from a hydraulic piston for vertical adjustment of the wheel directly connected to a suspension arm (not shown) which has a wheel steering adjustment hydraulic piston and a wheel axle rotation adjustment hydraulic piston (not shown).

A sophisticated hydraulic, electronic, software and object detection system can be applied, being responsible for making the calculations in milliseconds and adjusting each suspension independently, keeping the machine always level to plant correctly.

### Autopilot

The autopilot system is loaded with a planting map, that is, the planting line that the machine should follow, and through commands on the operator's monitor, it loads the planting map or guide map, and then starts moving the machine autonomously, automatically and independently of the operator over the line designed for planting. There are two options for planting lines: one goes above the fertilization line and the other follows the reforestation planting line in degraded areas, respecting the flora that has already been recovered; thus, the machine is capable of planting in recovery areas (reforestation) of environmental liabilities without interfering with the elements of the flora, which may be restoring the degraded environment in a natural way.

### Irrigation and Gel Application

The machine with planting system can be coupled to a water reservoir (50), to ensure the operation of the water injection system (post planting irrigation) and gel application for safer planting in times of greater water deficit. At the same time as planting, the machine prepares a “bowl” through the plate (33) pressing the soil to receive a calculated dose of water, which can vary according to the specifications determined for the planting and which is adjusted in the system that controls the planting. The operator, based on data passed as planting parameters, can select, via the system, how many liters the machine will apply after having injected the seedling. The selection of the amount of water applied ranges from 500 ml to 4 L per seedling (selection via the onboard system), and is applied by moving the water applicator in the opposite direction to the movement of the machine to prevent the excess water applied quickly from damaging the seedling, providing greater security for the plantations in periods with scarce rain.

Both the post-planting irrigation and the application of the planting gel can be configured to happen during the injection of the seedling or right after the injection of the seedling in the soil, that is, the gel can be applied together with the substrate and in the seedling hole, or over it, right after effective planting (injection of the seedling into the soil), where the water goes through the same process, and can be applied inside the soil or over the seedling, and this is configured in the system that controls the entire planting (software). It works with the following operations in this customization:
Optional planting with water and gel;
Dispensing of water from 500 ml to 4 L per optional change, with selection via the system;
The machine can optionally receive a quick coupling to couple the water dispensing system to a reservoir (50), which can be pulled by the machine;
The previous calculation of the maneuvering area ensures the handling of the machine coupled to a reservoir (50);
The machine can pull tanks (50) with up to 8,000 L of water and/or water and gel.

### Formicide Application

The machine can also receive a deposit of ant (56), located just above the planting system (18), which dispenses the programmed amount of ant just after planting the seedling. This system optimizes and anticipates the task of fighting ants, which is normally carried out after planting. For this purpose, it has a reservoir for 30 kg of ant killer and the ant dispenser system can be programmed in the control unit, establishing the moment when the ant killer will be released right after planting.

### GPS to Record the Position of the Seedling

The planting system records each change the position where each one was planted. The GPS position can use RTK (Real Time Kinematic) base or not. The seedling georeferencing system is activated via a monitor (57) that controls the planting and at the end of the operation generates a KML map (digital map) with the seedlings plotted in the plot where the planting was performed. The system records the planting result on a pen drive or can transfer it to the cloud so that it can be consulted via the machine's cloud system.

### Automatic Nozzle Height Adjustment in Relation to the Ground

The planting system has an exclusive system for checking the height of the ground, through an electronic and mechanical system formed by a radar (52) and a front camera (59). The reading of the “micro soil”, that is, the soil just below the planting beak (4) is essential to correctly inject the seedling, preventing the substrate from being exposed or the collection being buried. The system is formed by an electronic component and software, and both work as a redundancy to each other to establish the correct height of the place where the seedling will be injected, this procedure being carried out for each seedling, which guarantees the quality of planting and tree growth.

### Intelligent System for Quality Control of Planting

The machine's artificial intelligence system verifies through analysis of 3D images generated by the rear camera (53) if the seedling has a drowned collar, if the substrate is exposed, if the seedling is inclined or not, and displays it on the monitor (57) of planting control the image with a green background, if the planting is correct, and red if the planting has a defect or if the seedling was not planted for any reason, and registers the quality status of planting in the digital planting map planting each seedling. Therefore, the person responsible for planting (company or operator) will have on-site or cloud access to the final planting result, seedling by seedling.

### GPR (Ground Penetrating Radar) and Mechanical Verification of Ground Obstacles

The GPR system checks through a digital system and mechanically if there is any superficial obstacle, that is, above the ground, or if there is any buried obstacle (under the ground) that prevents planting (injection of the seedling) or the development of the future tree The main tests performed by the system are: verification of the presence of roots, stumps, clods, stones, trunks, sticks and any other object that prevents the planting or development of the tree. The system uses a kind of sonar—an ultrasonic sensor of the height of the nozzle (58)—that penetrates the ground and performs at the same time and redundantly a mechanical test, that is, it buries a metal bar (not shown) to have sure that there is no object preventing the planting of the seedling.

Obstacle tests are carried out along the entire planting line, that is, while the machine is moving, the test is constantly performed up to the position of the spacing established for planting each seedling, if in the exact location where the seedling should be planted (injected) there is an obstacle, the machine decides to plant the seedling centimeters before the established spacing, where there is no obstacle. For example, if the planting has a spacing of 3 meters, and in the third meter there is an obstacle, the machine decides to plant in the previous position that has no obstacle, being able to plant at 2.95 m, 2.90 m, 2.85 m and so on. This decision is exclusive to the machine and is carried out based on the calculations of where the planting was designated (distance between seedlings) and if there is any obstacle in the place where the seedling would be planted. The objective here is to prevent the planting from being compromised by obstacles.

### Sliding Planting and Continuous System

The continuous planting sliding system (18) guarantees the planting of seedlings independent of the synchronism between the machine's displacement speed and the planting speed and represents the most important characteristic of the machine, since the other known machines that plant nursery seedlings depend exclusively on the synchronism between their displacement speed and the speed at which the planting system touches the ground.

To this end, the planting system is also built by other essential components, such as the revolving supply of seedlings (3) which is composed of a rotating support (16) of bases (17) for seedling trays that receives an axis (15) that allows circular movement, having coupled cylinders (13) that act to lower and raise the tray support, facilitating the supply of seedlings and replenishment at the end of planting the initial load of trays with seedlings, also having a fixing rod (14) on the machine body.

Another essential component is the carousel (1) supported by a support (23) that is fixed to the machine structure, which has a bearing hub (22) that guarantees clockwise movement supported by a support (25), being driven by a hydraulic motor (31) that propels the entire system by moving the carousel clockwise to release one seedling at a time into the first stage tube (29), this one that has a lid (28) that prevents the seedlings from falling out of the tube where they are waiting to be planted; still having a helical pinion (26) that guarantees the clockwise movement and a planetary gear (27), which works as a kind of rack to allow the clockwise displacement of the entire carousel and thus release one seedling at a time during the whole planting, also having a turning reducer (30), which assists in the movement to release one seedling at a time that will come out of each tube of the first stage (29), and in said tube (29) the operator deposits 30 seedlings, which they will be planted one by one; and it also has a second stage waiting tube for the seedlings (24), in which the seedling, when leaving the carousel (1), waits until the planting nozzle (4) finishes the “injection” of a seedling, and goes up to catch the next seedling, having a guide ring (32), whose system opens the door (28) of the first stage tube (29) to allow the seedling to fall into the second stage tube (24).

Another essential component is the leveling and sliding system formed from a horizontal linear guide (5), which allows the horizontal displacement of the planting nozzle (4) throughout the work, serving as a platform for moving forward and backward, and that has a leveling platform (19), which allows the vertical leveling of the entire system, a bearing hub (20), which allows the radial movement of the leveling assembly to guarantee the leveling of the entire planting beak (4), and a rack (21), contact point of the helical pine (45) to ensure the forward displacement of the entire planting beak system at the end of the “injection” of a seedling, and the beginning of a new cycle of planting a new seedling; this guide (5) is mounted next to a support structure (2) that is fixed to the machine body, and receives a turning point (6), this system to level and stabilize the planting beak (4) and that guarantees that the beak always plants the seedlings in a perpendicular position to the sky, preventing the seedling from inclining; receives leveling cylinders (7), which act to help level the planting nozzle (4) during machine displacement and whenever the machine tilts due to obstacles in the ground, such as stones, stumps, roots, which can incline the machine and compromise the quality of planting; a transverse tensioner (8) that works together with the turning point (6) to level the planting beak (4); a longitudinal tensioner (9), which prevents torsion movements of the entire leveling and stabilization system; a transverse tensioner support (11), which prevents transverse twisting of the entire system that makes up the planting beak (4); and a support for the leveling cylinder (12), being the coupling point of the leveling cylinders (7) with the structure of the entire system, which is fixed to the machine body.

Coupled to the horizontal linear guide (5) there is the planting beak (4), which is built from a structure with a straight horizontal carriage (38), which allows horizontal movement; a helical pinion (45) that ensures the displacement of the planting beak in the linear guide (5) being connected to the rack (21); a cylinder (40) that moves in and out of the soil of the planting beak and is mounted next to the support (41); vertical linear guide (46), which allows the displacement up and down of the entire planting beak, allowing it to approach and move away from the earth, so that it is positioned at the correct height to “inject” the seedling, without drowning the seedling. collect and without exposing the substrate; horizontal sliding skid (47), which allows displacement of the nozzle on the linear guide (5) that moves forward with the action of the hydraulic motor (44) and at the same machine speed in the opposite direction to the displacement of the machine during the “injection” of the seedling; vertical sliding skate (48), which allows the nozzle to move up/down to get in and out of the ground; planting beak cone (49), which is a kind of guide to ensure that the seedling falls inside the external beak (34) and internal beak (35), before being “injected” into the soil; cylinder (42), which rotates on the axis of the inner beak (35), guided inside the outer beak (34) to open the “door” that will allow the seedling to be “released” into the soil, or that is, planted, “injected”; vertical front carriage (36), which allows the up/down movement of the spout; said external nozzle (34), the seedling “injection” nozzle formed by the external nozzle (34) and the internal nozzle (35), two cylindrical and conical pieces inserted one inside the other, where the external nozzle (34) works as a kind of guide and support for the inner beak (35), the inner beak that rotates around its own axis and guided by the outer beak, causes the rear opening of the planting beak and “releases” the seedling during planting; the turning movement on the axis of the inner beak inside the outer beak, opens the rear part of the planting beak and allows “planting” the seedling in the soil, which is called “injecting” the seedling, without material movement (earth) and without making a hole that makes it difficult to plant seedlings without inclination, that is, standing perpendicular to the sky, not the ground; and said internal beak (35), forms, together with the external beak (34), the repository of the seedling while waiting for the planting beak (4) to enter the ground and the opening of the rear part of the beak that happens due to the turning on the axis of the inner beak within the outer beak; the external and internal beaks, when closed, form a kind of conical cylinder, which protects the seedling, preventing it from falling before planting and also protects the seedling during its entry into the soil of the planting beak, serving as a protective capsule for the seedling, and as a kind of “needle” that penetrates the earth without causing much movement of the earth, which facilitates the stability of the seedling in the soil; it also has a compacting plate (33), which compacts the earth to form the basin that will dam the water around the seedling; compactor plate cylinders (37), which together with the nitrogen pressure accumulator, work as a spring maintaining the necessary pressure for the plate (33) to make the basin to dam the water around the seedling; a cylinder support (39), where the cylinders that make the up/down movement of the compaction plate that forms the basin for damming water around the seedling are fixed; planting beak support (43), which serves to fix the external (34) and internal (35) beak; and a hydraulic motor (44), which guarantees the horizontal and linear movement of the planting beak (4).

The hydraulic motor (44) drives the nozzle (4) forward on the linear guide (5), when returning to the zero point, the nozzle is unlocked and returns by inertia, that is, sliding backwards at the speed at which the machine is being displaced by the planting area, during the seedling “injection” process. The motor acts to move the planting nozzle to the planting position and is “unlocked” or turned off to ensure that the nozzle moves (slides) backwards in the opposite direction to the movement of the machine, during planting, in inertial movement in the same speed with which the machine moves forward planting. This is the great differential of the system of the invention in relation to any other planting machine for nursery seedlings-the fact that it does not require synchronization between the machine's displacement speed and the speed at which the nozzle “injects” the seedling into the soil, and remains in contact with the ground.

In the case of the present invention, due to the sliding and continuous planting system (18) that uses inertia to slide the planting beak (4) in the opposite direction to the movement of the invention, there is no need for synchronization between the speed of the machine and the speed at which the beak touches and remains in the ground when planting each seedling. This feature of the machine guarantees planting quality and greater planting efficiency for each seedling, and avoids planting transfers, that is, it is unnecessary to keep a helper in the soil replanting seedlings, due to the guarantee of quality in the planting of each seedling. There is no risk of the machine moving faster or slower and the beak changing its way of planting. As the nozzle (4) moves in inertia by the horizontal linear guide (5) which is the support of the planting system (18), regardless of the machine displacement speed, the nozzle will always perform all its functions from start to finish, without compromising the quality of planting and without failing to plant any seedlings, and without cutting down any seedlings during planting.

The machine plants one seedling per second and, depending on the terrain conditions, can plant up to 3,600 seedlings per hour. The first 30 seedlings arranged in trays in the rotating supply (3) being placed on the carousel (1), before starting planting and fed constantly during planting by the planting operator, so that the carousel does not run out of seedlings. When the machine finishes planting all the seedlings, it is necessary to stop and reload the machine with new trays (3) full of new seedlings.

The continuous planting sliding system (5) has a rotating tray delivery system composed of a support (23) that supports a circular carousel (1) that rotates the tubes containing seedlings (29) in a clockwise direction, dispensing at least duct (24) one seedling at a time in the funnel (49) that leads to the spouts (34) (35). The system has a horizontal linear guide (5), with a hydraulic motor system (44) and leveling cylinders (7) for adjusting the angle of the planting system, which allow the planting nozzle system (4) to move horizontally, which is coupled to a vertical sliding skid (48) which is an intermediate structure that moves vertically and adjusts itself in relation to the height of the ground, and which is coupled to a hydraulic cylinder (40) for moving the beak that moves vertically to plant the seedlings; the nozzle support (43) comprises a cylinder (42) that controls the opening of the external (34) and internal (35) nozzles to release the seedling into the soil, having a plate (33) with tips, like needles, with springs that hold them to the ground during machine movement, and ultrasonic nozzle height sensors (58); the external planting nozzle (34) is controlled by the hydraulic piston (42) and the system also has a rear camera (53) that monitors the operation after planting, and water and gel supply hoses coming from their reservoirs.

During the entire planting process, the nozzle reads the height of the ground (58), to maintain the correct height between it and the ground and thus carry out the planting by injecting the seedling in such a way as not to expose the substrate or drown the collection.

As soon as planting begins, the soil reading system scans the planting site with radio frequency reading to check if there is any obstacle in the soil that prevents the “injection” of the seedling into the soil, and makes a second check that tests the resistance of the soil, to make sure that there are no obstacles that prevent planting the seedling. Obstacles can be roots, stones, clods, trunks or any dirt that makes planting difficult.

Once the soil is read, the seedling injector nozzle (4) makes an upward movement to open the intermediate compartment between the seedling carousel (1) and the funnel (49), receives a seedling, and makes the downward movement to “inject” the seedling into the soil.

The seedling injector system guarantees clean, fast, efficient and jam-free planting, having been specially developed for planting in rainy weather, which prevents possible locks of the mechanism even when operating in more sticky soils.

The machine's development stages indicated that the biggest problem faced by the user of other technologies in planting with planting nozzle or planting wheel, is precisely the mud, which renders the equipment inoperative. With that in mind, a self-cleaning system (not illustrated) was developed, which is located inside the nozzle, which prevents the accumulation of mud in the planting nozzle. In short, the inner spout (35) has an internally welded plate (not shown) and when the outer spout (34) is moved, especially on its way back up, the plate that is immobile acts touching the mud together with the water that is dispensed.

The system can operate at speeds of up to 8 km/h in the following configuration according to the model shown below:
Allows planting with variable spacing selected by the system;
Reinforced module for planting up to 72,000 seedlings/day or 100,000 kilometers;
Adjustable planting spacing via software directly on the machine's console;
Does not require synchronization with machine speed;
Easy maintenance hydraulic system;
Self-locking return to base system;
Operates at speeds up to 8 km/h;
Completes a planting cycle in up to 1 s;
Can be configured through the central computer;
It has a sliding axis of at least 2.5 m;
Makes a basin for water accumulation;
Presses the seedling to remove air pockets around the seedling substrate;
Checks for obstacles when injecting the seedling into the soil;
It reads the micro soil to adjust the height of the nozzle in relation to the soil;
Records the GPS position of each seedling in a digital planting map that will be sent to the cloud;
On the digital planting map, the system indicates the planting quality status of each seedling;
Displays the planting of each seedling on a monitor, indicating if it was planted correctly, if there was a problem and it was not planted, or if it was planted with a problem;
Verifies planting quality using an intelligent system.

### Seedling Injector System

The planting nozzle or seedling injector system has unique characteristics that guarantee greater quality in planting and seedling development. Above the planting beak (4) there is the funnel that conducts the seedling (49), whose function is to direct a seedling that will be released to the planting beak, after planting a seedling, when the beak makes the vertical upward movement to pick up the next seedling. This subsystem was created to guarantee the quality and precision of planting.

The system reads the micro soil to adjust the height between the nozzle and the soil to ensure that the substrate will not be exposed and the collection will not be “drowned”.

It reads buried objects by radar that may prevent the seedling from being injected into the soil, and mechanically reads the soil looking for objects that may prevent the planting and correct development of the seedling in the tree. When injecting the seedling, it creates a basin that helps the accumulation of water around the seedling and irrigates the seedling by dispensing water along with the seedling inside the hole or pouring water over the planted seedling and also applies planting gel along with the substrate in the soil.

### Carousel

The machine can transport the equivalent of 5 hectares of seedlings, and it can transport more, however the total number of seedlings was calculated to finish planting at the same time that the machine empties the reservoir that takes the water or planting gel, this measure of seedlings was based on a total of 1667 seedlings per hectare as the standard. The planting carousel (1) moves up to 30 seedlings at a time, which guarantees the planting of lines of 90 meters or more and the feeding system for new seedlings in the carousel is manual—currently, the operator places the seedlings by taking them out of the tray and placing on the carousel. Future versions will feature a robotic system for placing seedlings on the carousel, but due to the severe conditions faced in the planting and reforestation reform areas, it is possible to choose to use the manual replacement of seedlings on the carousel.

The seedlings move on the carousel one by one as they are dispensed through the funnel (32) which is located between the carousel (1) and the planting nozzle direction funnel (49).

The operator places each seedling in waiting tubes (29) so that he moves clockwise to dispense the seedlings one by one into the funnel (32), and this process is continuous until the end of planting. Remove a tray with up to 200 seedlings from the shelf (60), place it next to it, and take the seedlings off the tray and place them on the carousel (1). Optionally, the operator can fill the carousel with several seedlings at once to rest.

The empty trays are placed on the shelf (60), next to other trays without seedlings. Once all the seedlings have been placed on the carousel (1) and all the trays are empty, the machine makes a brief stop to unload the empty trays and load the machine with trays full of seedlings. At the same time that the empty trays are unloaded from the planting machine, the operator can complete the reservoir (50) that is coupled to the machine with water or planting gel.

### Machine Management and Control System

The machine's management system was developed to make the operation and handling of the seedling planting machine an intuitive, friendly task, which does not require any specific training from whoever is going to operate the machine, in order to allow any operator, regardless of the degree of technical knowledge can start operating the machine in minutes, without problems and without danger for those who operate and for those in the field.

A machine that has a planting system has wheels with fenders equipped with a hydrostatic engine, with a carousel operator's seat composed of a monitor (57) and a pilot's seat composed of monitors and a steering wheel, with an earth compressor (51) coupled by support arm and adjusted by hydraulic piston; being composed in the front part of radar (52), front camera (59) and rear camera (53) to verify planting quality seedling.

The system is intuitive, self-explanatory, and has a modern assistance system, showing videos for each task and to solve any doubt about the operation and maintenance of the machine. The video lessons with content on every detail of the operation and maintenance of the machine, visually present and using the equipment itself, each particular function of the same in detail. All of these systems can be accessed by the pilot's and machine operator's displays.

The machine operation monitor is touch sensitive and rugged for field conditions.

All operating options can be accessed quickly and easily. And the operation is 100% visual, that is, the icons that give access to the machine's functionalities, are icons illustrating with real photos, every detail and every part of the machine.

The system, whenever it locates an internet point, will request access to the WI-FI network from the operator in order to download any new update of the machine's software automatically and without any need for operator interference. There is also the option of updates via pen drive, that is, physically in the slot available for this purpose on the machine. This option guarantees a permanent update of the machine's systems, always bringing new resources, improving existing resources, and making the process more efficient and simpler every day.

The system can be accessed by the monitor (57) in the command cabin (10) and machine direction or by the monitor next to the planting operator. As there are two operators on the machine, one can access the systems via the cockpit and the other through the planting operator on the side of the machine.

Through the management and control system, the operator can confirm the planting parameters, such as spacing between seedlings, amount of water in seedling irrigation, amount of planting gel that will be applied to the seedling, whether the water will be released underground or above the seedling, if the gel will be dispensed underground along with the substrate, amount of ant killer and whether or not the machine will apply ant killer and where the ant killer will be released; the system presents the planting status for each seedling, with indicative and self-explanatory images of the planting result (it presents the image of the newly planted seedling with a green box if the planting was correct and a red box if the planting has a defect and indicates the defect), the system displays all information about machine operation, planting speed, total seedlings, external temperature, machine oil temperature, fuel quantity and autonomy, time until the end of the planting shift, planting duration and countless other pieces of information to guide the pilot and the machine operator during their working day on board the machine.

### Operation and Telemetry System

The telemetry system presents all the operating parameters of the machine, being a redundant system and complementary to the operation system, and its main objective is to display, in a clear and concentrated way, in a single graphic interface, all the telemetric information of the machine.

The main information displayed by the system is: fuel and autonomy, amount of water in the barrel, amount of ant poison, total seedlings planted, duration of planting and time for the end of the working day, ambient temperature, oil temperature in the machine, level of oil in the hydraulic systems, status of each subsystem of the machine, both hydraulic and mechanical subsystems, and of the elements that make up the machine.

The telemetry system displays warnings and alerts to indicate any failure or potential problem that could compromise the proper functioning of the machine and the quality of planting.

### Hydrostatic Transmission

The hydrostatic transmission system simplifies the propulsion of the machine, being an addition to the machine, it allows the same to move forward, backward, avoid obstacles, climb obstacles up to a certain height, change machine gauge to allow it to move through debris that forms a very high barrier, higher than the ability to lift your smart suspension.

### Remote Monitoring

The remote monitoring system is a system designed to ensure the remote monitoring of the machine, its remote maintenance and updating, and the checking of all machine components remotely.

The system is triggered in preventive reviews as soon as it finds an internet connection. It connects to the manufacturer and starts the machine maintenance checklist autonomously.

Once the tests are completed, the system stores the result of the preventive review in the equipment itself and sends the status of all machine systems and the suggested need for maintenance or component replacement to the owner customer.

### Georeferencing Position Record of Each Seedling in a Digital Database

The georeferencing system uses third-party GPS equipment (55) which, connected to the machine system, captures and records the position of each planted seedling, through an antenna (54), to generate a digital planting map at the end of planting.

The seedlings are georeferenced with greater or lesser precision depending on the equipment used and the technology employed.

When using the georeferencing system, the accuracy will be centimeters away. Synchronized with the planting system, each time the planting beak injects a seedling, the position of the seedling is simultaneously requested to be recorded in the machine's database and later transmitted these maps or recorded on a pen drive to transport this data.

The machine also has its own system in the cloud for recording planting maps and querying them.

### Artificial Intelligence to Analysis of Planting Quality

The intelligent system that checks the quality of planting performs numerous checks, including: seedling inclination, stem drowning, substrate exposure and whether the seedling was planted or not.

To indicate a correct planting, the system displays each seedling and a green box on the planting operator's monitor, which represents a correct planting. If the planting is incorrect, the box will be red and a message on the screen will alert to the incorrect planting. The system counts the seedlings that were planted with defects and indicates the GPS position of the problems.

The technology employed is the analysis of 3D images, with several cameras to have a complete view and from all angles of the plant in the ground.

### Real-Time Presentation of Planting Quality

The consequence of adopting an activity management model allows all machine activities to be recorded in the database and automatically transferred to the cloud and/or to the company's system, uploading the information as soon as the machine identifies an authorized internet connection. The quality control of the planting takes place through the use of the system, checking each of the photos, of each of the planted seedlings. The system identifies in the image any failure in the planting, in the sinking of the collar, exposure of the substrate, when there are problems in the inclination of the seedling.

The machine receives a tool that allows remote monitoring of the machine, through your computer or tablet.

With the integration of the machine to the integrated management system, greater control of all activities is achieved, ranging from planting to forest management in real time (depending on the availability of internet on site). The machine is ready for operation with a map of the planting that will be carried out, spacing between rows, spacing between seedlings, and records all information about the planting of each seedling in the database.

The user has access to the platform that controls the planting maps to manage forest management services. The gain in productivity and the increase in security in the planting process is the differential of the embedded technology, allowing the user to manage their agricultural projects using the services available after planting that can be controlled and managed based on the GPS position of each seedling.

### Functionalities

The machine with its sliding system admits planting at any displacement speed, without the need for synchronization between the systems and allows planting in any type of soil, changing the planting speed automatically, presenting the following operating steps:
Dispenses seedlings automatically;
Apply gel (optional);
Apply water to each seedling (optional);
Apply formicide (optional);
Verifies the quality of the planting—sinking of the collection, exposure of the substrate and seedling inclination;
Records information on the planting quality of each seedling in a base date;
Records GPS position of each seedling;
Creates basin for water accumulation;
Compress soil where the seedling was planted to remove pockets of air inside the earth;
Interchangeable planting nozzle for quick maintenance in the field;
Planting system copies soil irregularities to plant at the correct height;
Planting system checks objects or obstacles when planting, to avoid planting over stumps, roots, trunks, stones, etc.

The embedded technology allows the recording of data in the cloud to present the planting map online, adding to the planting service the georeferencing control of the seedlings, thus resulting in cost optimization with real-time monitoring of planting success, in addition to allowing the automation of the processes necessary for forest management.

From the moment the invention is used for planting forests, processes can be automated, such as: point-to-point fertilization of seedlings, irrigation of seedlings, combating pests around the tree, forest inventory, and analysis of the health of the forest, all of this using the same mechanical and technological platform of the patent and autonomously, that is, without the need for an operator.

This planting machine very efficiently replaces various agricultural implements, such as: planting equipment, irrigation equipment, ant control equipment and quality control team, bringing in addition to considerable savings in planting forests, greater efficiency, more quality and speed in planting seedlings.

In the scenario of a market in constant evolution, the machine is the cheapest and fastest solution for planting exotic and/or native species in continuous operation, being able to work up to 20 hours a day, with quick stops to receive new trays with seedlings, from time to time.

The machine can plant any kind of nursery seedling of native, exotic, fruit or ornamental plants (eucalyptus, mahogany, pine, coffee, avocado, orange, lemon, MPB, among others). The machine presents functionality and efficiency for both forestry planting and reforestation. The spacing between seedlings is selected during planting and can vary according to the needs of the project, with adjustable intervals of 1 meter.

The spacing between seedlings is done through selection via the system, and can be adjusted during planting with increments of 1 meter, from a minimum of 2 meters—that is, 2, 3, 4, 5, 6, 7 meters and so on.

### System Operation

The operation of a machine with the planting system occurs as follows: In first place comes the loading of 18 trays or more with the seedlings that will be planted, with an average of 200 seedlings per tray. An average of 4,000 seedlings can be loaded, which will coincide with the total amount of water in the kite and the need to stop to refill the reservoir (50). The machine drags the reservoir (kite) with approximately 8,000 liters of water and can irrigate an average of 4 liters per seedling, that is, the machine has an average capacity to irrigate up to 2,000 seedlings (or more) and plant 2,000 seedlings per charging cycle. This way, when the machine finishes planting the 2,000 seedlings, it will be time to reload the barrel and unload the empty seedling trays and load new trays with 200 seedlings.

The second step is to load the ant poison deposit (56).

The third step will be to load the planting map and planting sketch that will command the autopilot so that the machine moves over the fertilization line that was previously carried out, that is, the planting company first subsoils and fertilizes the soil, it records the GPS fertilization line on a pen drive and then loads the GPS data that contains the line where the fertilizer was buried so that the machine plants where the fertilizer is buried. The planting sketch contains the characteristics established by the company for planting, which are: spacing between seedlings, amount of water in irrigation, amount of gel applied to each seedling, whether the irrigation will be buried or over the seedling, if the gel will be released into the soil together with the substrate or on top of the seedling, where the ant killer and its quantity will be dispensed, and all the other parameters necessary for planting.

The fourth step is to start the machine's systems, both for operating the machine and the planting system, and to carry out the automatic self-tests, that is, the checklist of the systems, verifying that each system is operational and without defects. This step checks each hydraulic system, each electronic system, the monitoring cameras, the intelligent system, the control systems, all the logic gates of the machine, the pistons, the opening of the planting nozzle, the movement of the carousel, and all the other systems and subsystems. After this stage, optionally, if the machine has a compactor roller (51) at the front, it goes down until it touches the ground and presses the soil as the machine moves to create a regular and homogeneous surface accumulating soil in the middle, this soil will be necessary to prevent the seedling from being planted in a ditch and at the same time the accumulation of this material will be useful for the formation of the basin that will hold irrigation or rain water.

The fifth step is to load the carousel (1) with 30 seedlings to start planting. In this step, the operator selects a tray with seedlings from the revolving supply (3), places it next to the chair on the shelf (60) where he will follow all the work of the machine (onboard), and dispenses the seedling into the tubes (29) from the carousel. The carousel is made up of 30 tubes that receive and dispense (release) one seedling at a time.

The sixth step is to position the machine on the first planting line recorded in the GPS and press the “start” command to start planting.

In the seventh step, the system moves the carousel (1) forward one position clockwise, the individual seedling deposit (29) opens, a seedling is dispensed into the funnel (32) which leads the seedling to the cone (49), where the seedling awaits the movement of the planting beak (34) upwards, which will open the deposit to release the seedling and start planting the first seedling.

The eighth step is reading the micro soil to plant the first seedling, checking if there are any obstacles that prevent the injection of the seedling.

The ninth step consists of lowering the nozzle (4) to the correct height, the correct height for seedling injection is calculated by the machine's radar system (52) and the sensor (58) that operate in redundancy, that is, one system validates the data of the other and vice versa. The external beak (34) then penetrates the earth, opens the inner beak (35) to release the seedling, starts the ascent while the compactor plate (33) forms the basin to receive the irrigation and starts the descent compressing the earth, removing pockets of air, and forming the irrigation basin. Optionally, the machine, when opening the nozzle door (35) inside the soil, can activate a solenoid valve (not shown) that will allow the injection of gel into the soil together with the substrate or even the dispensing of water inside the soil together with the substrate. Once planting is completed and the formation of the basin to receive the irrigation, the machine raises the nozzle (34) and returns it to the initial position, where it will wait for the command to pick up the next seedling.

The tenth step is the upward movement of the nozzle (34) and cleaning that will remove excess mud inside the nozzle. It is important to remove the accumulated mud inside the nozzle, to prevent the nozzle from stopping working.

The eleventh step is to read the soil through GPR to check, as the machine moves, if there is any obstacle that prevents the nozzle from correctly planting the seedling. The main obstacles that can prevent the planting and correct development of the seedling and future tree are: clods of earth, sticks, trunks, roots, stumps, debris from cutting trees in areas of reform.

The twelfth step is, starting from the spacing defined for planting, defining where the seedling can be planted, that is, the operator defined that the spacing will be every 2 meters, but in the 2nd meter there is a superficial or buried obstacle, in this case, as the machine moved and read all the soil in the planting line, the machine itself will be able to decide where to plant and be sure that in the selected position there will be no obstacles. The planting position will no longer be the 2nd meter, but after the seedling previously planted and after at least 1 meter, any place that is free can be a valid planting position. However, the next seedling will be planted, or at least the machine will try to plant, 4 meters away from the first seedling planted, to try to maintain a correct alignment in the planting row for future tree growth. The need to break the spacing due to the obstacles that may exist, forces the machine to misalign some seedlings, but it will try to realign the seedlings below to form a forest with more uniform spacing.

The thirteenth step is to dispense the ant poison at the correct distance and in the quantity specified by the planting sketch.

The fourteenth step is to dispense irrigation water in a continuous system from the reservoir (50) in the opposite direction to the movement of the machine, being able to release from 500 ml to 4 L of irrigation with water or gel on top of the seedling.

The fifteenth step is to register with a photo the image of the seedling planted right at the end of the injection and creation of the basin around the seedling to verify the quality of the planting, evaluating parameters such as: the inclination of the seedling, if the collar is “drowned” or no, if the substrate is exposed or not and a score for the planting quality of each seedling, recording all this data in the machine's system memory so that as soon as the machine connects to the internet, it will automatically upload all the planting data to the cloud in order to allow the person responsible for the planting to consult and save all the information related to that planting in a KML map with the GPS position of each seedling.

The machine will repeat the above steps until the seedlings run out. In this case, the machine will make a brief stop to load new trays with more seedlings, and fill the reservoir (50) with water or planting gel, in addition to completing the reservoir of ant poison (56).

The planting status can be updated to the cloud in real time, if there is an internet network available at the planting site, or at the end of planting via pen drive or transfer via internet network. The planting status file contains all the information about how the seedlings were planted, the planting quality changes the seedling, the position of each seedling, and all information regarding the planting and the machine during planting.

It is important to point out that the figures and description made do not have the ability to limit the ways of executing the proposed inventive concept, but rather to illustrate and make the conceptual innovations revealed in this solution understandable. Thus, the descriptions and images must be interpreted in an illustrative and non-limiting manner, and there may be other equivalent or analogous ways of implementing the inventive concept now revealed and that do not deviate from the spectrum of protection outlined in the proposed solution.

1. AUTOMATED SYSTEM FOR PLANTING NURSERY SEEDLINGS introduced in a self-propelled machine, with engine with radiator and gearbox having a power that can vary from 130 to 190 hp, with electronic injection and can perform the gears automatically according to the load, which has wheels with fenders equipped with a hydrostatic engine, with a carousel operator's seat (1) consisting of a monitor and a pilot's seat inside the cabin (10) consisting of a monitor (57) and steering wheel, with an earth compressor (51) coupled by a support arm and adjusted by a hydraulic piston; being composed in the front part of radar (52), front camera (59) and rear camera (53), and georeferencing system that uses GPS equipment (55) that captures and records the position of each seedling planted, through an antenna (54), to generate a digital planting map at the end of planting;
the machine can also use a hydrostatic transmission system with independent and intelligent suspension on each wheel, which identifies obstacles ahead for each wheel and calibrates the hydraulic suspension to move the piston of each suspension up or down independently, the suspension being formed from a hydraulic piston for vertical adjustment of the wheel directly interconnected to a suspension arm that has a hydraulic piston for adjusting the direction of the wheel and a hydraulic piston for adjusting the rotation of the wheel axis; and characterized in that it is formed by the rotating seedling supply (3) which is composed of a rotating support (16) of bases (17) for the seedling trays that receives an axis (15) that allows circular movement, having coupled cylinders (13) that act to lower and raise the tray support, also having a fixing rod (14) on the machine body; and the seedling trays can be supported on shelves (60);
a) carousel (1) supported by a support (23) which is fixed to the machine structure, which has a bearing hub (22) that ensures clockwise movement supported by a support (25), being driven by a hydraulic motor (31) that propels the entire system by moving the carousel clockwise to release a seedling per turn to the first stage tube (29), which has a lid (28) that prevents the seedlings from falling out of the tube where they are waiting to be planted; still having a helical pinion (26) and a planetary gear (27), which operates as a rack, also having a gear reducer (30) that helps in the movement to release one seedling at a time that will come out of each tube of the first stage (29), and in said tube (29) 30 seedlings are deposited, which will be planted one by one; and it also has a second stage waiting tube for the seedlings (24), in which the seedling leaves the carousel (1), waits until the planting nozzle (4) finishes the “injection” of a seedling, and goes up to pick up the next seedling, having a guide ring (32), whose system opens the door (28) of the first stage tube (29) to allow the seedling to fall into the second stage tube (24);
b) horizontal linear guide (5), which allows the horizontal displacement of the planting beak (4), serving as a forward and backward displacement platform, and that has a leveling platform (19), which allows the vertical leveling of the entire system, a bearing hub (20), which allows the radial movement of the leveling assembly for leveling the entire planting beak (4), and a rack (21), contact point of the helical pine (45) for the forward displacement of the entire planting beak system at the end of the “injection” of a seedling, and the beginning of a new planting cycle of a new seedling;
c) the guide (5) is mounted next to a support structure (2) that is fixed to the machine body, and receives a turning point (6), this system to level and stabilize the planting beak (4) and which guarantees that the beak always plants the seedlings in a perpendicular position to the sky; it receives leveling cylinders (7), which work by helping to level the planting beak (4) during machine displacement; a transverse tensioner (8) that works together with the turning point (6) to level the planting beak (4); a longitudinal tensioner (9), which prevents torsion movements of the entire leveling and stabilization system; a transverse tensioner support (11), which prevents transverse twisting of the entire system that makes up the planting beak (4);
and a support for the leveling cylinder (12), being the coupling point of the leveling cylinders (7) with the structure of the entire system, which is fixed to the body of the machine;
d) coupled to the horizontal linear guide (5) there is the planting beak (4), which is built from a structure with a straight horizontal carriage (38), which allows horizontal movement; a helical pinion (45) that performs the displacement of the planting beak in the linear guide (5) being connected to the rack (21); a cylinder (40) that moves in and out of the soil of the planting beak and is mounted next to the support (41); vertical linear guide (46), which performs the downward and upward displacement of the entire planting beak; horizontal sliding skid (47), which allows displacement of the nozzle on the linear guide (5) that moves forward with the action of the hydraulic motor (44) and at the same machine speed in the opposite direction to the displacement of the machine during the “injection” of the seedling; vertical sliding skate (48), which allows the beak to move up/down to enter and exit the earth; planting beak cone (49), which causes the seedling to fall inside the external (34) and internal (35) beak, before being “injected” into the soil; cylinder (42), which rotates on the axis of the internal beak (35), guided inside the external beak (34) to open the “door” that will allow the seedling to be “released” into the soil; vertical front carriage (36), which makes the up/down movement of the spout; said external nozzle (34), the seedling “injection” nozzle formed by the external nozzle (34) and the internal nozzle (35), two cylindrical and conical pieces inserted one inside the other, where the external nozzle (34) works as a guide and support for the inner beak (35), the inner beak that rotates around its own axis and guided by the outer beak, causes the rear opening of the planting beak and “releases” the seedling during planting; it also has a compacting plate (33), which compacts the earth to form the basin that will dam the water around the seedling; compactor plate cylinders (37), which together with the nitrogen pressure accumulator, work as a spring maintaining the necessary pressure for the plate (33) to make the basin to dam the water around the seedling; a cylinder support (39), where the cylinders that make the up/down movement of the compaction plate that forms the basin for damming water around the seedling are fixed; planting beak support (43), for fixing the external (34) and internal (35) beak; and a hydraulic motor (44), which makes the horizontal and linear movement of the planting nozzle (4) in the linear guide (5), when returning to the zero point, the nozzle is unlocked and returns by inertia, sliding backwards in the speed at which the machine is being moved across the planting area, during the seedling “injection” process; still having a reservoir (50) with around 8,000 L of water that is dragged by the machine and can irrigate an average of 4 L per seedling;
and the planting nozzle (4) has an ultrasonic sensor of height of the nozzle (58), which penetrates the ground and performs at the same time and redundantly to the radar system (52) a mechanical test, verifying that there is no object preventing the planting of seedlings; being able to have a self-cleaning system located inside the nozzle (34), which prevents the accumulation of mud, in which the internal nozzle (35) has an internally welded plate and when there is movement of the external nozzle (34), on its return in the ascent, the plate that is immobile acts touching the mud together with the water that is dispensed.

2. SYSTEM, according to claim 1, and characterized in that the machine can be coupled to a reservoir (50) for the operation of the water injection system (post planting irrigation) and gel application.

3. AUTOMATED METHOD FOR PLANTING NURSERY SEEDLINGS reproduced by the system of claim 1, and characterized by the following steps:
a) 18 trays or more are loaded into the rotary supply (3) with the seedlings to be planted, with an average of 200 seedlings per tray;
b) The formicide deposit (56) is loaded;
c) The planting map and planting sketch are loaded, which will command the autopilot so that the machine moves over the fertilization line that was previously carried out;
d) Start up the machine systems, both machine operation and the planting system and perform automatic self-tests;
e) The carousel (1) is loaded with 30 seedlings to start planting;
f) The machine is positioned on the first planting line recorded in the GPS and the “start” command is activated to start planting;
g) The system moves the carousel (1) forward one position clockwise, the individual seedling deposit (29) opens, a seedling is dispensed into the funnel (32) which leads the seedling to the cone (49), where the seedling awaits the movement of the planting beak (34) upwards, which will open the deposit to release the seedling and start planting the first seedling;
h) The micro soil is read to plant the first seedling, checking if there are obstacles that prevent the injection of the seedling;
i) The nozzle (34) is lowered to the correct height for seedling injection, which is calculated by the radar system (52) and by a sensor (58) operating in a redundancy system, verifying the opposite pressure exerted by the soil on the planting beak, increasing the planting efficiency of each seedling;
j) Once the planting is completed and the formation of the basin by the dish (33) to receive the irrigation, the spout is raised and returns to the initial position, where it will wait for the command to receive the next seedling;
k) When the nozzle (34) goes up, cleaning takes place, which will remove excess internal mud;
l) The soil is read before the nozzle enters the earth through GPR (Ground Penetration Radar) to check, as the machine moves, if there is any obstacle that prevents the nozzle (34) from planting the seedling correctly;
m) From the spacing defined for planting, it is defined where the seedling can be planted;
n) The formicide is dispensed at the correct distance and in the quantity specified by the planting sketch;
0. Irrigation water is dispensed in a continuous system from the reservoir (50) in the opposite direction to the movement of the machine, being able to release from 500 ml to 4 L of irrigation with water or gel on top of the seedling;
p) The image of the planted seedling is registered with a photo at the end of the injection and creation of the basin around the seedling to verify the quality of the planting, evaluating parameters such as: the inclination of the seedling, if the collar is “drowned” or not, whether the substrate is exposed or not and a score for the planting quality of each seedling, recording all this data in the machine's system memory so that the machine connects to the internet, automatically upload all the planting data to the cloud in order to allow the person responsible for the planting to consult and save all the information related to that planting in a KML map with the GPS position of each seedling;
q) The machine will repeat the aforementioned steps until the seedlings are finished; and when finished, it will stop to load new trays with more seedlings, and complete the reservoir (50) with water or planting gel, in addition to completing the reservoir of ant poison (56).

4. METHOD, according to claim 3, and characterized in that in step c) recording the GPS fertilization line on a pen drive or digital memory and then load the GPS data that contains the line where the fertilizer was buried so that the machine plants where the fertilizer is buried; and the planting sketch contain characteristics established for planting, such as: spacing between seedlings, amount of water in irrigation, amount of gel applied to each seedling, whether irrigation will be buried or over the seedling, whether the gel will be released inside of the soil along with the substrate or above the seedling (29), where the ant killer and its quantity will be dispensed, and all the other parameters necessary for planting.

5. METHOD, according to claim 3, and characterized in that after step d), if the machine has a compactor roller (51) at the front, this goes down until it touches the soil and presses the soil as the machine moves to create a regular and homogeneous surface accumulating soil in the middle.

6. METHOD, according to claim 3, and characterized in that in step e) the operator selects a tray with seedlings from the shelf (60), places it next to the chair where he will follow the work of the machine (onboard), and dispenses each seedling in the positions of the carousel inside the tubes (29); where the carousel (1) is formed by 30 tubes (29) that receive and dispense one seedling at a time.

7. METHOD, according to claim 3, and characterized in that in step i) optionally, when opening the door (35) of the planting nozzle inside the earth, you can activate a solenoid valve that will allow the injection of gel into the earth together with the substrate or even dispense water into the earth together with the substrate.

8. METHOD, according to claim 3, and characterized in that in step i) while planting, preparing a “basin” through the plate (33) pressing the soil to receive a calculated dose of water, which may vary according to the specifications determined for the planting and which is adjusted in the system that controls the planting; and the operator, based on data passed as parameters for planting, can select, via the system, how many liters the machine will apply after having injected the seedling; and the selection of applied water varies from 500 ml to 4 L per seedling (selection via embedded system).

9. METHOD, according to claim 3, and characterized in that in step I) the system uses an ultrasonic nozzle height sensor (55) that penetrates the soil and performs at the same time and redundantly a mechanical test, burying a metal bar to verify that no object is preventing the planting of the seedling.

10. METHOD, according to claim 3, and characterized in that in step m) the operator defines the spacing and finds a superficial or buried obstacle in the next planting, the system can decide where to plant and make sure that there are no obstacles in the selected position; and from the next seedling, plant at a uniform distance in relation to the previous seedling to maintain a correct alignment in the planting line.
